(19) United States
(12) Patent Application Publication
(10) Pub. No.: US 2008/0192716 A1
(43) Pub. Date: Aug. 14, 2008

(54) METHOD AND APPARATUS FOR REPORTING 3GPP AND NON-3GPP INTERWORKING CAPABILITIES OF A MULTIMODE WTRU

(75) Inventor: Kamel M. Shaheen, King of Prussia, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/027,307

(22) Filed: Feb. 7, 2008

Related U.S. Application Data
(60) Provisional application No. 60/888,785, filed on Feb. 8, 2007.

(51) Int. Cl. H04Q 7/24

(52) U.S. Cl. 370/338

(57) ABSTRACT

A method for reporting interworking capabilities of a multimode capable wireless transmit/receive unit (WTRU) includes the WTRU transmitting a first message, including network interworking capability of the WTRU, the WTRU transmitting a second message including radio interworking capability of the WTRU, and the WTRU receiving a third message including network availability.

### CROSS REFERENCE TO RELATED APPLICATIONS

This application claims the benefit of provisional application No. 60/888,785, filed Feb. 8, 2007 which is incorporated by reference as if fully set forth.

### FIELD OF INVENTION

The present invention is related to wireless communication.

### BACKGROUND

A goal of the Third Generation Partnership Project (3GPP) Long Term Evolution (LTE) program is to develop new technology, new architecture and new methods for settings and configurations in wireless communication systems in order to improve spectral efficiency, reduce latency and better utilize the radio resource to bring faster user experiences and richer applications and services to users with lower costs.

A wireless transmit/receive unit (WTRU) may possess multiple mode capability. For example, some WTRUs may have multiple radio units that support General Packet Radio Service/Global System for Mobile Communications (GPRS/GSM) air interfaces, Universal Mobile Telephone Service (UMTS) air interfaces, Enhanced UMTS Terrestrial Radio Access Network (E-UTRAN) air interfaces, Wireless local area network (WLAN) interworking with GSM/GPRS/GSM/EDGE Radio Access Network (GERAN) (GAN), I-WLAN air interfaces (802.11, 802.16, and the like), Trusted non-3GPP systems (802.11, WiMAX, 802.16, and the like), and Fixed Broadband Interworking.

FIG. 1 is a block diagram of a baseline architecture of a 3GPP system 100 in accordance with the prior art. The system 100 may include a first WTRU 102 in direct communication with a GERAN 130, a second WTRU 104 in direct communication with a UTRAN 128, and a third WTRU 106 in direct communication with a WLAN 108. The GERAN 130 and the UTRAN 128 may connect at a serving GPRS support node (SGSN) 126 that communicates directly with a short message service-gateway/interworking mobile switching center (SMS-GMSC/SMS-IWMSC) 132 and a gateway GPRS support node 124. The SMS-GMSC/SMS-IWMC may communicate directly with a short message service swith center (SMS-SC) 134 while the GGSN 124 communicates directly with a public data network (PDN) 118, a multimedia resource function planner (MRFP) 122 and an IP multimedia subsystem-media gateway (IMS-MGW) 120, which are all tied to an IMS 116. The PDN 118 and the IMS 116 may be directly connected to a Packet Data Gatway (PDG) 114, which directly communicates with a wireless access gateway (WAG) 112. The WAG 112 may access the WLAN 108 directly, and the WLAN 108 has a direct link to the Internet 110.

A WTRU may receive and transmit information elements (IEs). An Information Element is a group of information that may be included within a signalling message, such as set parameters, user identifiers and the like. For example, an existing IE in the 3GPP specification is a network capability IE. The MS_Network_Capability IE indicates general WTRU characteristics and is independent of frequency band. TABLE 1 shows a prior art network capability IE.

TABLE 1

MS network capability value [24.008]
:=<GEA1 bits>
<SM capabilities via dedicated channels:
bit>
<SM capabilities via GPRS channels:
bit>
<UCS2 support: bit>
<SS Screening Indicator: bit string(2)>
<SoLSA Capability : bit>
<Revision level indicator: bit>
<PFC feature mode: bit>
<Extended GEA bits>
< LCS VA capability: bit >
<Spare bits>;

The MS network capability IE includes 1 bit to indicate a GPRS encryption algorithm (GEA), 1 bit to indicate short messaging (SM) capabilities via dedicated channels, 1 bit to indicate SM capabilities via GPRS channels, 2 bits to indicate supplemental service (SS) screening, 1 bit to indicate Support of Localized Service Area (SoLSA) capability, 1 bit to indicate Universal Character Set 2 (UCS2) support, 1 bit to indicate revision level, one bit to indicate support for Packet Flow Control (PFC) feature mode (Base Station Subsystem (BSS) packet flow), 1 bit to indicate support for Location Services value added (LCS VA) location request notification and extended GEA bits.

Another IE typically used in the 3GPP scheme is a radio access capability IE. The MS Radio Access IE is used to provide part of the network with information concerning the radio aspects of the WTRU. Table 2 shows an existing radio access capability IE.

The MS radio access capability IE is a large IE that has multiple bits indicating support for a large number of radio technologies. In general, the IE includes 4 bits to indicate support for the access technology type, and bits that indicate support, for example, for Frequency Domain Division (FDD), Time Domain Division (TDD) and Code Division Multiple Access (CDMA) radios, among others.

TABLE 2

<MS RA capability value part := [24.008]
<Access Technology Type >
<Access capabilities : bit>
< UMTS FDD Radio Access Technology
Capability : bit >
< UMTS 3.84 Mcps TDD Radio Access
Technology Capability : bit >
< CDMA 2000 Radio Access Technology
Capability : bit >
< UMTS 1.28 Mcps TDD Radio Access
Technology Capability: bit >

Accordingly, it would be beneficial if a system and method existed that allowed a WTRU to provide multiple mode capability information to the network, particularly in one or more IEs.

### SUMMARY

The present invention is related to a method and apparatus for reporting Third Generation Partnership Project (3GPP) and non-3GPP interworking capabilities of a multimode wireless transmit/receive unit (WTRU). The multi-mode WTRU may inform a core network about its multimode interworking service capability during an attachment procedure by transmitting an IE that includes WTRU interworking capability data.

Additionally, the core network may inform the WTRU of the availability of interworking to other technologies such as I-WLAN or an evolved core network. This may also be done with an IE that includes network interworking capability data.

### BRIEF DESCRIPTION OF THE DRAWINGS

A more detailed understanding may be had from the following description, given by way of example and to be understood in conjunction with the accompanying drawings wherein:

FIG. 1 an overview of a 3GPP and Non-3GPP interworking network architecture in accordance with the prior art;

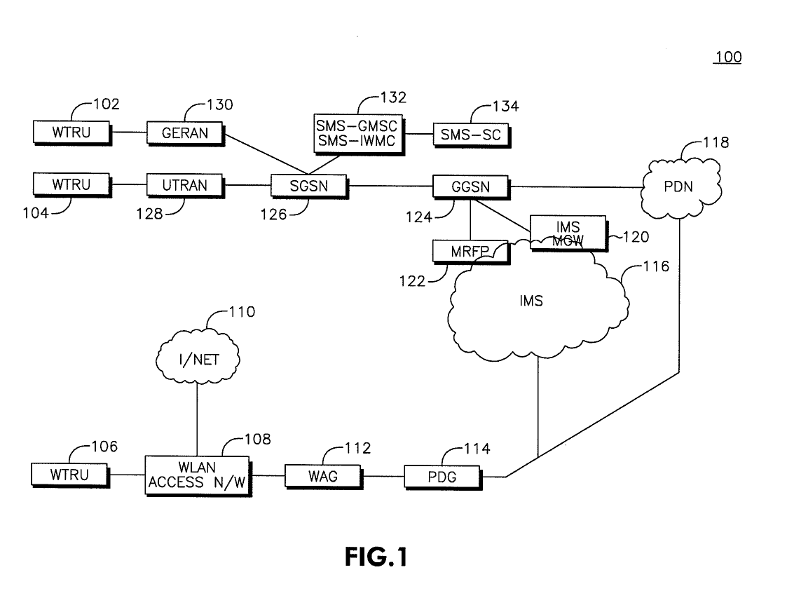

FIG. 2 shows an example of a wireless communication system in accordance with one embodiment;

FIG. 3 shows a functional block diagram of a WTRU and an Node B of FIG. 2;

FIG. 4 is an functional block diagram of network components in accordance with one embodiment;

FIG. 5 is a signal diagram of an attachment procedure with interworking capability updating in accordance with one embodiment.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “base station” includes but is not limited to a Node-B, a site controller, an access point (AP), or any other type of interfacing device capable of operating in a wireless environment.

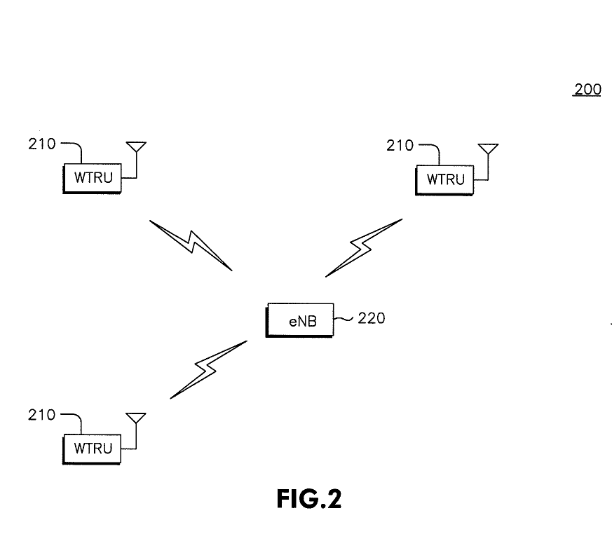

FIG. 2 shows a wireless communication system 200 including a plurality of WTRUs 210 and a e Node B 220. As shown in FIG. 2, the WTRUs 210 are in communication with the Node B 220. Although three WTRUs 210 and one Node B 220 are shown in FIG. 2, it should be noted that any combination of wireless and wired devices may be included in the wireless communication system 200.

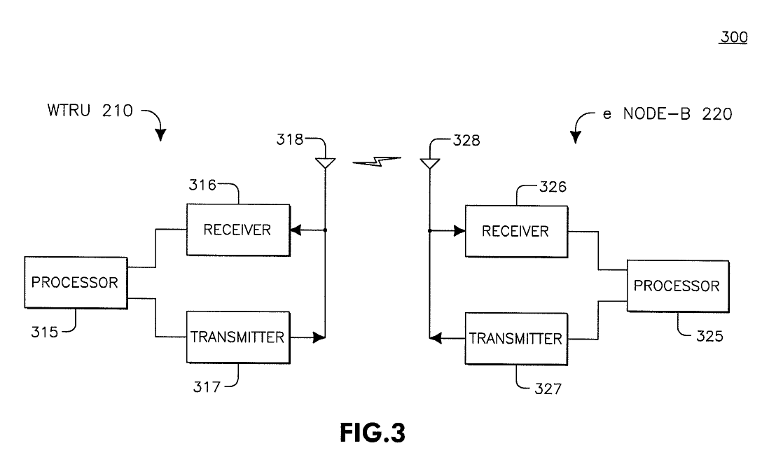

FIG. 3 is a functional block diagram 300 of the WTRU 210 and the Node B 220 of the wireless communication system 200 of FIG. 2. As shown in FIG. 2, the WTRU 210 is in communication with the Node B 220 and both are configured receive and transmit IEs as necessary.

In addition to the components that may be found in a typical WTRU, the WTRU 210 includes a processor 315, a receiver 316, a transmitter 317, and an antenna 318. The processor 315 is configured to process IEs as necessary. The receiver 316 and the transmitter 317 are in communication with the processor 315. The antenna 318 is in communication with both the receiver 316 and the transmitter 317 to facilitate the transmission and reception of wireless data.

In addition to the components that may be found in a typical Node B, the Node B 220 includes a processor 325, a receiver 326, a transmitter 327, and an antenna 328. The processor 325 is configured to process IEs as necessary. The receiver 326 and the transmitter 327 are in communication with the processor 325. The antenna 328 is in communication with both the receiver 326 and the transmitter 327 to facilitate the transmission and reception of wireless data.

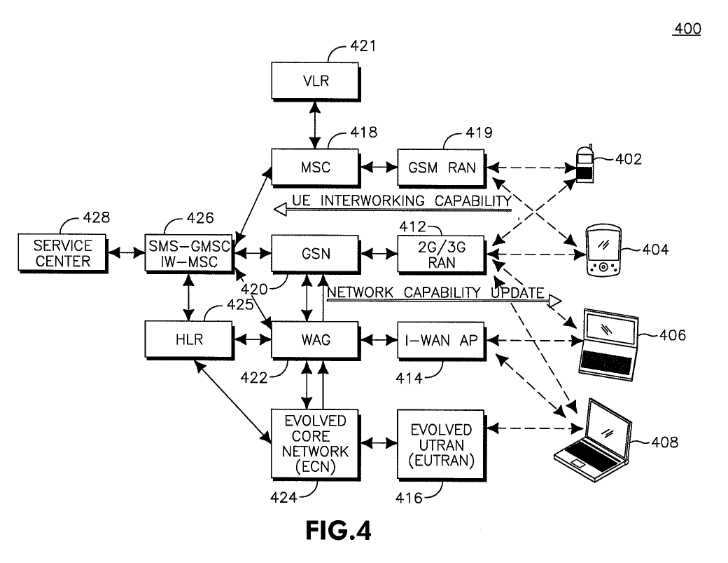

FIG. 4 is a block diagram of network components in accordance with one embodiment. A WTRU may comprise, but is not limited to, a handset 402, a Personal Digital Assistant (PDA) 404, a legacy laptop computer 406 and a modern laptop computer 408, for example. The handset 402 and the PDA 404 may communicate with a GSM radio access network (RAN) 410 and a RAN 412 compliant with 3GPP or its predecessor (2G/3G RAN). The legacy computer 406 may communicate with the 2G/3G RAN 412 and an I-WLAN access point (AP) 414. The modern laptop 408 may communicate with the 2G/3G RAN, the I-WLAN AP, or the E-UTRAN 416. Each of the WTRUs (402, 404, 406 and 408) may transmit their capability to function on multiple networks to the various networks (410, 412, 414, 416). In turn, the GSM RAN 410 may pass the capability information to a mobile switching center (MSC) 418 and a visited location register (VLR) 421. The 2G/3G RAN 412 may pass the capability information to a GPRS support node (GSN) 420. The I-WLAN AP 414 may pass the capability information to a wireless access gateway (WAG) 422 which may communicate with a home location register (425). The E-UTRAN 416 may pass the capability information to an Evolved Core Network (ECN) 424, which may communicate with the HLR 425. Each of the networks (410, 412, 414, 416) may transmit a Network Capability Update to the WTRUs (402, 404, 406, 408) containing information about the existence of I-WLAN interworking capabilities and the different types of services that can be provided over the E-UTRAN either directly from a WAG, or indirectly from a GSN or an MSC through a SMS-GSMC/IW-MSC and a service center.

The WTRU capability reporting contains an information element (IE), which indicates the support of E-UTRAN at the terminal level. The IE may include, but is not limited to, technology information (e.g., Orthoganol Frequency Division Multiple Access (OFDMA), Wideband CDMA (WCDMA), and the like), supported bandwidth (e.g., 5 MHz, 10 MHz, 15 MHz, 20 MHz, and the like), bit rates, and Quality of Service (QoS) support.

Table 3 below shows a network capability IE in accordance with one embodiment. The network capability IE contains 3 bits to indicate support for six non-3GPP technologies. Although 3 bits are shown, on skilled in the art would realize that a fewer or greater number of bits may be unitized, depending upon how many different types of technologies must be indicted in the IE. For example, the bits may indicate support for 802.11 and 802.16 GAN cells, I-WLAN cells, WiMAX cells, and fixed broadband cells.

TABLE 3

```
  MS network capability value [24.008] :=<GEA1
  bits>
  <SM capabilities via dedicated channels: bit>
  <SM capabilities via GPRS channels: bit>
<Non-3GPP system Interworking Capability: 3
  bits,
    000 GAN Cell (802.11)
    001 GAN Cell (802.16)
    010 I-WLAN (802.11)
011 I-WLAN (802.16)
    100 WiMAX
    011 Fixed Broadband >
  <UCS2 support: bit>
  <SS Screening Indicator: bit string(2)>
```

Table 4 below shows a radio access capability IE in accordance with an embodiment. The radio access capability IE contains 3 bits to indicate support for six non-3GPP technologies. For example, bits may indicate support for 802.11 and 802.16 GAN cells, I-WLAN cells, WiMAX cells, and fixed broadband cells.

Both the MS Network Capability Access IE and the MS Radio Capability Access IE include information that may inform the network about the multimode interworking capabilities of the WTRU. The Radio Access Capability IE carries all aspects of the EUTRAN capabilities including, but not limited to, technology information, bandwidth information, scalability, bit rates, quality of service (QoS), and may also include terminal type (PDA, Laptop, phone), memory size, screen size, and processing power.

TABLE 4

```
<MS RA capability value part := [24.008]
<Access Technology Type >
<Access capabilities : bit>
< UMTS FDD Radio Access Technology
Capability : bit >
< UMTS 3.84 Mcps TDD Radio Access
Technology Capability : bit >
<Non-3GPP system Interworking Capability:
3 bits,
  000 GAN Cell (802.11)
  001 GAN Cell (802.16)
  010 I-WLAN (802.11)
  011 I-WLAN (802.16)
  100 WiMAX
  011 Fixed Broadband >
```

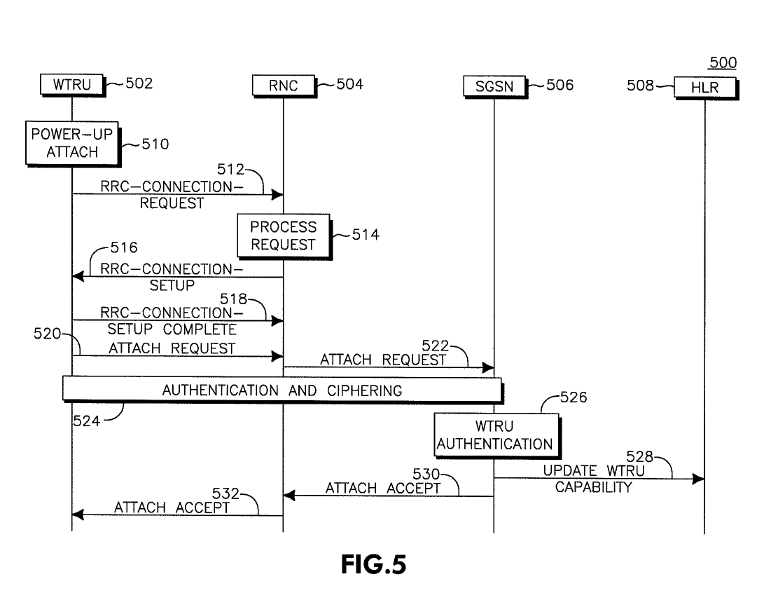

FIG. 5 is a signal diagram of an attachment procedure 500 with interworking capability updating between a WTRU 502, an RNC 504, an SGSN 506 and an HLR 508. When a WTRU 502 is powered up, it first communicates via UMTS channels. The WTRU begins a non-access stratum (NAS) “ATTACH” procedure 510 to exchange information with a core network.

The WTRU 502 transmits a message with a RRC_Connecton_Request 512 to an RNC 504. The message may also include a packet temporary mobile subscriber ID (PTMSI), a routing area ID (RAI) and a CAUSE IE. The RNC 504 processes the request, performs admission control and checks the availability of resources 514. The RNC 504 transmits a message including an RRC_CONNECTION_SETUP 516 with a UTRAN Radio Network Temporary Identifier (URTNI) to the WTRU 502. The WTRU 502 may then transmit an RRC_CONNECTION_SETUP_COMPLETE message 518 to the RNC 504, followed by an ATTACH Request 520. The ATTACH request 522 may then be forwarded by the RNC 504 to the SGSN 506. The Network Capability IE and/or the Radio_Access Capability IE may be included in the ATTACH request 522.

The ATTACH request may also include the PTMSI and an international mobile subscriber ID (IMSI). The WTRU 502, RNC 504 and SGSN 506 perform authentication and ciphering 524, the SGSN 506 authenticates 526 the WTRU 502 and the SGSN 506 sends an update 528 to the HLR 508 containing the WTRU multimode capabilities. An Attach accept message 530 is transmitted from the SGSN 506 to the RNC 504. The RNC 504 forwards the attach accept 532 to the WTRU 502.

Although the features and elements are described in particular combinations, each feature or element can be used alone without the other features and elements or in various combinations with or without other features and elements. The methods or flow charts provided may be implemented in a computer program, software, or firmware tangibly embodied in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) module.

What is claimed is:

1. A method for reporting third generation partnership project (3GPP) and non-3GPP interworking capabilities of a multimode capable wireless transmit/receive unit (WTRU), the method comprising:
the WTRU transmitting a first message, wherein the message comprises network interworking capability of the WTRU;
the WTRU transmitting a second message, wherein the second message comprises radio interworking capability of the WTRU; and
the WTRU receiving a third message, wherein the third message comprises network availability.

2. The method as in claim 1 further comprising the WTRU transmitting the first message and the second message during an ATTACH procedure.

3. The method as in claim 1 wherein the first message is a network capability information element.

4. The method as in claim 1 wherein the second message is a radio capability information element.

5. The method as in claim 3 wherein the network capability information element comprises an indication of a WTRU's multiple network compatibility.

6. The method as in claim 5 further comprising representing the WTRU's multiple network compatibility in a fixed number of bits.

7. The method as in claim 4 wherein the radio capability information element comprises an indication of a WTRU's multiple radio compatibility.

8. The method as in claim 7 further comprising representing the radio capability information in a fixed number of bits.

9. A method of reporting multiple operating mode capability of a wireless transmit/receive unit (WTRU), the method comprising:
transmitting a request to attach to a network; and
receiving a confirmation of attachment, wherein the request to attach to the network comprises an indication of WTRU multiple mode capability.

10. The method as in claim 9 further comprising the WTRU transmitting a radio resource controller (RRC) connection request signal including any of the following: Packet Temporary Mobile Subcriber Identifier (PTMSI), Routing Area Identifier (RAI) and/or CAUSE registration.

11. The method as in claim 9 further comprising the WTRU receiving an RRC connection setup signal including a UTRAN Radio Network Temporary Identifier (URNTI).

12. The method as in claim 9 wherein the indication of WTRU multiple mode capability is included in a network capability information element.

13. The method as in claim 9 wherein the indication of WTRU multiple mode capability is included in a radio capability information element.

14. A method of reporting interworking capability in a multimode wireless transmit/receive unit (WTRU), the method comprising:
the WTRU transmitting a network capability information element (IE); and
the WTRU transmitting a radio capability IE, wherein the network capability IE comprises an indication of WTRU network interworking capability and the radio capability IE comprises an indication of WTRU radio interworking capability.

15. The method as in claim 14 wherein the indication of WTRU network capability comprises a fixed number of bits within the network capability IE.

16. The method as in claim 14 wherein the indication of WTRU radio capability comprises a fixed number of bits within the radio capability IE.

17. The method as in claim 15 wherein the indication of WTRU network capability includes an indication of network interworking capability with any one of the following: an IEEE 802.11 GAN Cell; an IEEE 802.11 I-WLAN, an IEEE 802.16 GAN cell; and IEEE 802.16 I-WLAN, a WiMAX network, and a fixed broadband network.

18. The method as in claim 16 wherein the indication of WTRU radio capability includes an indication of radio interworking capability with any one of the following: an IEEE 802.11 GAN Cell; an IEEE 802.11 I-WLAN, an IEEE 802.16 GAN cell; and IEEE 802.16 I-WLAN, a WiMAX network, and a fixed broadband network.

19. A wireless transmit/receive unit (WTRU) comprising:
a receiver configured to receive an indication of a network interworking availability;
a transmitter configured to transmit an indication of a WTRU interworking capability.
